(19) United States
(12) Patent Application Publication
(10) Pub. No.: US 2023/0289739 A1
(43) Pub. Date: Sep. 14, 2023

(54) PUBLICIZING MEETING SCHEDULE OVERRUNS TO CONSECUTIVE MEETING ATTENDEES

(71) Applicant: Avaya Management L.P., Durham, NC (US)

(72) Inventor: Liam Loftus, Galway (IE)

(21) Appl. No.: 17/689,772

(22) Filed: Mar. 8, 2022

(51) Int. Cl. G06Q 10/10

(52) U.S. Cl. CPC G06Q 10/1095

(57) ABSTRACT

Meetings often run long and when the do, attendees of one meeting are often delayed to a subsequent meeting. A meeting attendee may establish a message announcing the overrun of the first meeting. Upon the occurrence of an event, such as time beyond the first meeting's end, the message is sent. The recipient may be individuals or other systems, such as a messaging system that then propagates the notification to the attendees or moderator of the subsequent message.

### FIELD OF THE DISCLOSURE

The invention relates generally to systems and methods for the automatic generation of event messages.

### BACKGROUND

Conference participants often have consecutive meetings scheduled. While participating in a first meeting, it may become obvious to an attendee that such meeting will overrun into the time of a subsequent meeting. Their attendance at the subsequent meeting may even be required, such as to form a quorum or to chair/present content. Often, the participants in the subsequent meeting are standing idle while they wait for the required attendee to join. The participants standing idle usually have no indication that a previous meeting of the delayed participant is overrunning, or how quickly the delayed participant may be in joining the subsequent meeting.

A delayed participant may call or send a text or email message to either the organizer of the following meeting or a reply-all email to the meeting invite list to advise that they are running late or the duration of their delay. The message may advise the attending participants on how to proceed, such as to reschedule, to address agenda items in a different order, or to just start without the delayed participant. Alternatively, the delayed participant may reschedule the meeting to another timeslot.

Notifying the attendees of a subsequent meeting while the first meeting is still ongoing, can be distracting—especially if the delayed attendee is presenting content in the first meeting. Such notifications often generate a lot of subsequent messages, such as to notify participants they are marginally delayed or actioning the delay (i.e. rescheduling, advising to start without them etc.). This has a negative impact on both meetings that are in progress—the overrunning meeting is interrupted by the delayed attendee who is distracted with notifying their next meeting of the delay, and the subsequent meeting is interrupted by these sporadic notifications advising of the delay.

Prior art approaches to notifying users of meeting overruns is inefficient. Usually, individual meeting participants manage overruns by multitasking (and often become distracted) to notify the subsequent meeting participants of a meeting overrun or spend time rescheduling the next meeting during a current meeting. This, in turn, often causes a further overrunning of the current meeting.

### SUMMARY

These and other needs are addressed by the various embodiments and configurations of the present invention. The present invention can provide a number of advantages depending on the particular configuration. These and other advantages will be apparent from the disclosure of the invention(s) contained herein.

If a meeting will go unattended, in whole or in part, by a scheduled attendee, systems and methods are provided to update the status of the delayed (or absent) attendee in the system and, in turn, inform the participants of the subsequent meeting of the delay or absence. The notification is provided without the distraction that commonly occurs when a delayed attendee attempts to notify participants of a subsequent meeting that a delay is occurring while the current meeting is still ongoing.

In one embodiment, presence status for the delayed attendee is updated to include a “near” status, such as to indicate a minimal delay. Other statuses may include a degree of the delay in relative terms (e.g., “minor,” “significant,” etc.) or an estimate of the actual delay (e.g., five minutes, one hour, etc.). The status may then be propagated to the individual participants' devices of the subsequent meeting. Optionally, the status message may be selectively propagated in accordance with a rule or setting, such as those determined by a meeting moderator to restrict notifications, thereby preventing all participants from being unnecessarily interrupted by a notification of a delayed attendee, which may not even impact all of the other participants. Notifications may be provided to all individuals when they are determined to be necessary, such as when the delayed participant is essential to the subsequent meeting, thereby permitting the remaining participants to reorder, delete, or amend the subsequent meeting's agenda items, or permitting them to cancel and reschedule the subsequent meeting. It should be appreciated that other message conveyances may be provided, such as an avatar of the delayed attendee that then delivers the message via text and/or generated or previously recorded speech.

In another embodiment, a conferencing platform enables setting a meeting schedule status change message. The message may further comprise a probability of the completion time of the prior meeting, event, commitment, etc. As a result, a moderator or other conference user can automatically and without human intervention trigger the automatic creation of a status change that further causes a message to be sent to certain, or all, parties involved (e.g., attendees, organizers, etc.) with the subsequent meeting (e.g. “Budget meeting is overrunning”, Probable Completion Time: 11:05 UTC).

The message may be published on the conferencing platform. For meetings in which the delayed attendee has a key role, such as organizer, presenter, etc., (e.g., not merely an attendee) the conferencing platform may publish the status to be visible to all participants. As a benefit, meeting organizers, hosts, and/or participants may determine how to proceed (e.g., wait for the attendee(s) who are delayed, commence with introductions/other agenda items, reschedule, etc.).

Meetings are often scheduled utilizing different platforms, such as those supporting in-person and remote conferences. In one embodiment, a message may be formatted and delivered to each platform to update each accordingly. Additionally or alternatively, a standards protocol can be established to share this schedule information across conference platforms, subject to a calendar examination of participants to determine the platforms being used i.e. Zoom, Teams etc.

While the status message may be generated and delivered automatically without human intervention, the delayed attendee may optionally edit the message, change the timing of the message, cancel the message in order to accommodate unique circumstances, and/or enable specific guidance to the next meeting participants on how best to proceed. Additionally or alternatively, meeting titles may be manually edited or system-edited. For example, the conferencing platform may access or maintain privacy or confidentiality indicators for meetings. If the overrunning meeting has such an indication of sensitive information in its title, (e.g., “Staff Reduction Meeting”), such sensitive information may be omitted or edited to be more generic (e.g., “Meeting”).

In one embodiment, a system is disclosed, comprising: a network interface to a network; a data storage; a processor; and wherein the processor: determines a time event has occurred, the time event being associated with a user; in response to the occurrence of the time event, accessing a corresponding calendar of the user to determine if the user has a subsequent meeting scheduled for the user; upon determining a subsequent meeting is scheduled for the user, generating a delay notification message; and sending the delay notification message, via the network, to at least one user associated with the subsequent meeting.

In another embodiment, a method is disclosed, comprising: determining a time event has occurred, the time event being associated with a user; in response to the occurrence of the time event, accessing a corresponding calendar of the user to determine if the user has a subsequent meeting scheduled for the user; upon determining a subsequent meeting is scheduled for the user, generating a delay notification message; and sending the delay notification message, via a network, to at least one user associated with the subsequent meeting.

In another embodiment, a system is disclose, comprising: means to determine a time event has occurred, the time event being associated with a user; means to, in response to the occurrence of the time event, access a corresponding calendar of the user to determine if the user has a subsequent meeting scheduled for the user; means to, upon determining a subsequent meeting is scheduled for the user, generate a delay notification message; and means to send the delay notification message, via a network, to at least one user associated with the subsequent meeting.

A system on a chip (SoC) including any one or more of the above aspects of the embodiments described herein.

One or more means for performing any one or more of the above aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above embodiments or aspects, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a system in accordance with embodiments of the present disclosure;

FIG. 3 depicts a process in accordance with embodiments of the present disclosure; and

FIG. 4 depicts a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

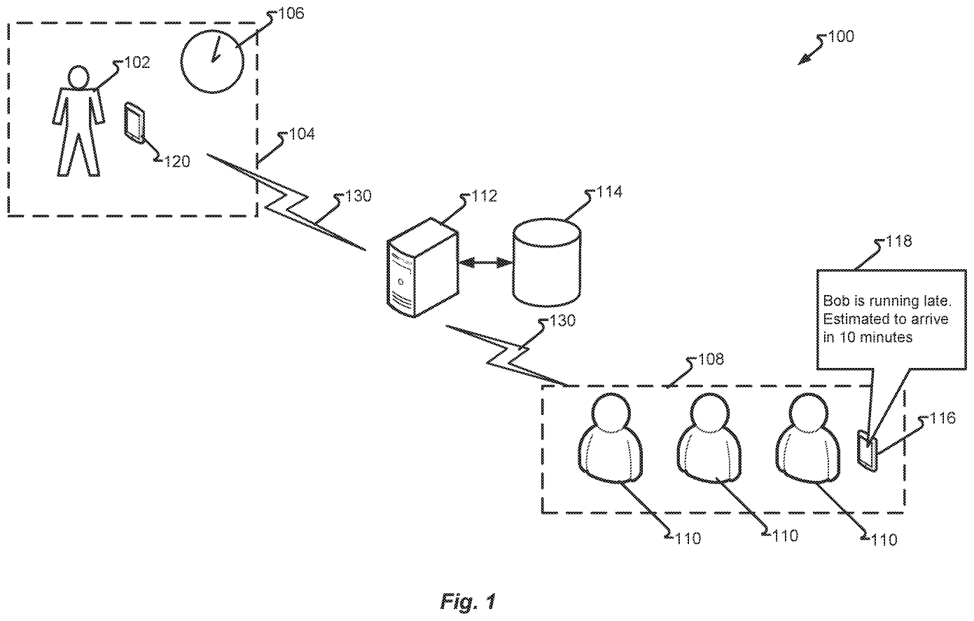

FIG. 1 depicts system 100 in accordance with embodiments of the present disclosure. In one embodiment, system 100 comprises delayed attendee 102 currently engaged in first meeting 104. First meeting 104 may be an in-person meeting, such as in a particular physical location (e.g., conference room, building, etc.), or a virtual meeting. As first meeting 104 progresses, a time event 106 occurs. Herein, time event 106 is represented by a clock to illustrate a current time that is now past the scheduled end time of first meeting 104.

In one embodiment, delayed attendee 102, a moderator or other organizer or participant of first meeting 104, established a conditional event, such as on server 112. The conditional event may comprise or access settings, rules, etc., which may further be maintained in data storage 114. Upon the occurrence of time event 106, server 112 determines whether a subsequent meeting exists for delayed attendee 102 that is scheduled to have a start time that makes attendance of delayed attendee 102 impossible for at least the start of subsequent meeting 108 when delayed attendee 102 is still attending first meeting 104. Here, subsequent meeting 108 is illustrated as a physical space to represent a physical meeting, such as in a conference room, building, etc., but subsequent meeting 108 may be a virtual meeting. However, both first meeting 104 and subsequent meeting 108 are meetings that, in no case, allow delayed attendee 102 to concurrently attend both first meeting 104 and subsequent meeting 108. Furthermore, there may be an additional delay from the time delayed attendee 102 discontinues attendance of first meeting 104 to the time delayed attendee 102 begins attendance of subsequent meeting 108, such as to move from one physical location to another, or to terminate one remote conference and reestablish a connection to another remote conference.

In another embodiment, server 112 triggers transmission to an address on network 130 that may be accessed by networked device 116 in order to receive delay notification message 118. Delay notification message 118 may comprise a notification of the believed extent of the delay, whether in relative terms (e.g., “significant,” “minor,” etc.) or objective terms (e.g., “five minutes,” “fifteen minutes,” etc.). As a benefit, subsequent meeting invitee(s) 110 may then alter subsequent meeting 108 to accommodate the delay, such as by adding, removing, or reordering an agenda, delaying the start time, canceling and rescheduling, etc. While server 112 and data storage 114 are embodied as discrete components, in other embodiments they may be combined or co-embodied. As a further option, the functionality of server 112 and/or data storage 114 may be co-embodied in a personal device, such as communication device 120, utilized by delayed attendee 102.

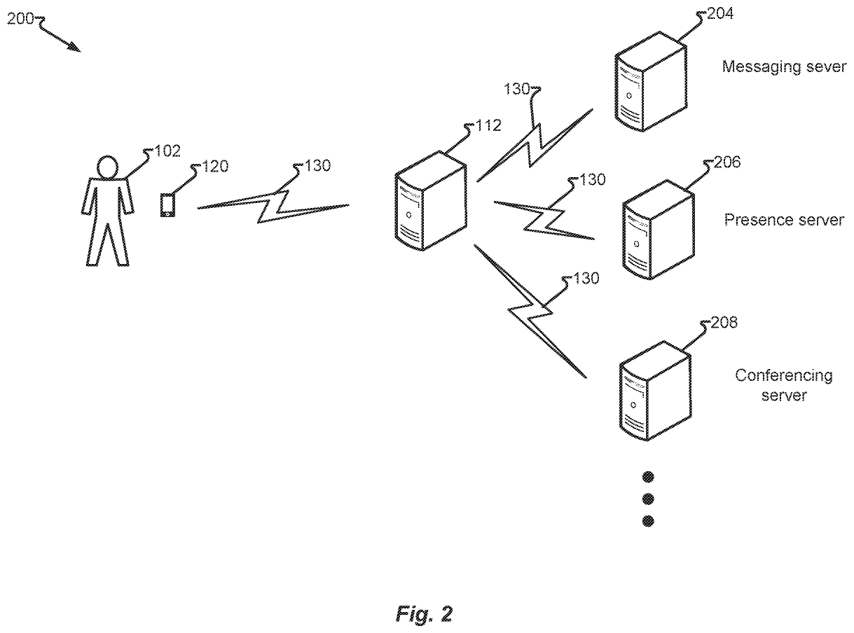

FIG. 2 depicts system 200 in accordance with embodiments of the present disclosure. Once a delay event has occurred, notification may be provided directly to one or more of the individuals associated with a subsequent meeting. In another embodiment, a delay notification message, such as delay notification message 118, may originate from a process of communication device 120 and/or server 112.

In turn, server 112 may propagate delay notification message 118 to one or more other components, such messaging server 204, presence server 206, conferencing server 208, etc. The propagation may be a forwarding or the conversion of the message from one format (e.g., data structure, protocol, etc.) to another. For example, server 112 may generate or obtain a delay notification message as an email message and then converts the message to another format and/or protocol, such as a Simple Message Service (SMS) text message, “ICS 213” message format, and/or any other format utilized by the recipient. Accordingly, a format/protocol of the sender (server 112) or recipient may be utilized. If the native format/protocol is not available to both the sender and recipient, a third format/protocol common to both the sender and recipient may be utilized.

In one embodiment, messaging server 204 may receive the delay notification message and propagate the message to one or more addresses on network 130. The propagation may include data conversion in accordance with the address time (e.g., email, text, etc.). For example, the delay notification message may indicate that a meeting arranged by “Bob Smith” cannot be attended by delayed attendee 102 on time. Accordingly, messaging server 204 may then generate a message to convey such information to the address associated with “Bob Smith.

In another embodiment, presence server 206 may receive the delay notification message and update the presence information for delayed attendee 102. For example, when attending first meeting 104, the presence status may be changed from “In Meeting” or “Unavailable” to “Delayed,” “Delay in attending the next meeting by five minutes,” etc.

In another embodiment, conferencing server 208 may maintain conferencing resources, such as remote access resources, scheduling components (e.g., automated transcription service), etc. Upon receipt of the delay notification message, conferencing service 208 may adjust the schedule of a resource to be utilized for the delayed meeting, such as subsequent meeting 108.

It should be appreciated that a delay in the attendance of delayed attendee 102 at subsequent meeting 108, may be a non-event when delayed attendee 102 is only an attendee and not a required participant. As a result, no action may be taken to alert and/or alter resources (human and/or non-human) of the delay. However, if delayed attendee 102 is a presenter, organizer, etc., then the impact is more of an event. A determination of the impact may be maintained in a record of data storage 114 (see FIG. 1) indicating the role of delayed attendee 102 in subsequent meeting 108.

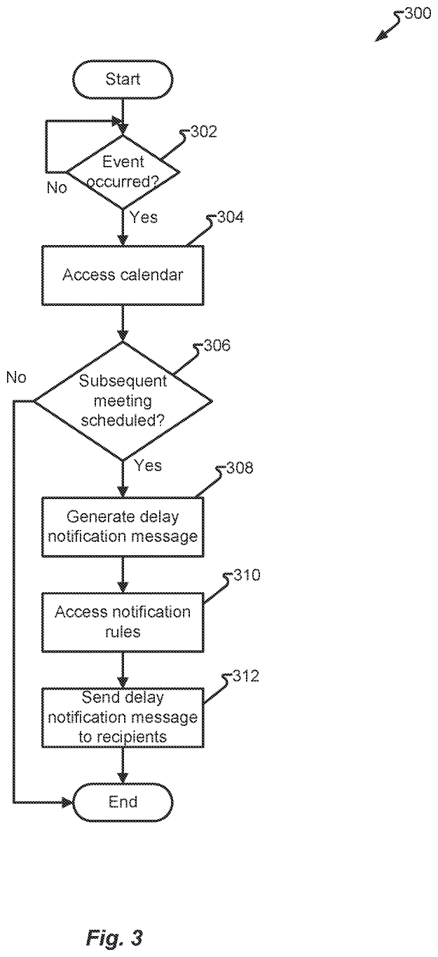

FIG. 3 depicts process 300 in accordance with embodiments of the present disclosure. In one embodiment, process 300 is embodied as machine-readable instructions maintained in a non-transitory storage that, when read by a machine such as a processor of at least one of server 112 and/or communication device 120, cause the processor to perform the steps of process 300.

In one embodiment, process 300 begins test 302 of determining if an event occurred, such as time event 106. Time event 106 may be established prior to the occurrence and, unless cancelled, occurs without human intervention. If test 302 is determined in the negative and the event has not occurred, process 300 may loop back to create a delay. Once the event occurs, test 302 will determined in the affirmative and processing continues to step 304.

Step 304 accesses a calendar for a user associated with the event, such as by accessing a calendar record of data storage 114. Then, test 306 determines if the user has a subsequent meeting scheduled. In one embodiment, a subsequent meeting is a meeting immediately following a current meeting (or other commitment of the user) wherein the end time of the current meeting and the start time of the subsequent meeting are the same. In another embodiment, a difference exists between the end time of the current meeting and the start time of the subsequent meeting, however, the event has occurred. Such a situation may result from the current meeting, such as first meeting 104, not ending on time and, as a result, not allowing any gap before the start of a subsequent meeting, such as subsequent meeting 108, to be sufficient, such as to account for travel and/or setup time.

If test 306 is determined in the negative, then process 300 may end. If test 306 is determined in the affirmative, then processing continues to step 308 wherein a delay notification message is generated, such as delay notification message 118. Step 310 then accesses notification rules, such as those that may be maintained in data storage 114 and/or communication 120. The parties determined as requiring notification, which may be all attendees of subsequent meeting 108 or a portion thereof or a non-attending organizer, may then be notified and, as a further option, any other systems, components, etc. (see FIG. 2). Step 312 then sends the delay notification message directly to the designated recipients or to the recipient via an intermediary server, such as server 112.

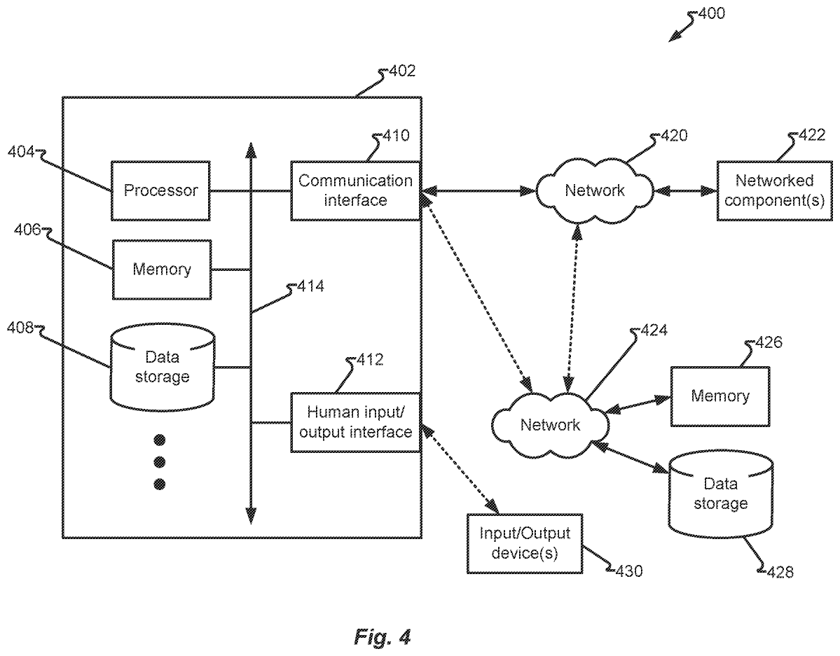

FIG. 4 depicts device 402 in system 400 in accordance with embodiments of the present disclosure. In one embodiment, server 112 and/or communication device 120 may be embodied, in whole or in part, as device 402 comprising various components and connections to other components and/or systems. The components are variously embodied and may comprise processor 404. The term “processor,” as used herein, refers exclusively to electronic hardware components comprising electrical circuitry with connections (e.g., pin-outs) to convey encoded electrical signals to and from the electrical circuitry. Processor 404 may comprise programmable logic functionality, such as determined, at least in part, from accessing machine-readable instructions maintained in a non-transitory data storage, which may be embodied as circuitry, on-chip read-only memory, memory 406, data storage 408, etc., that cause the processor 404 to perform the steps of the instructions. Processor 404 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 414, executes instructions, and outputs data, again such as via bus 414. In other embodiments, processor 404 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 404 is a non-transitory computing device (e.g., electronic machine comprising circuitry and connections to communicate with other components and devices). Processor 404 may operate a virtual processor, such as to process machine instructions not native to the processor (e.g., translate the VAX operating system and VAX machine instruction code set into Intel® 9xx chipset code to enable VAX-specific applications to execute on a virtual VAX processor), however, as those of ordinary skill understand, such virtual processors are applications executed by hardware, more specifically, the underlying electrical circuitry and other hardware of the processor (e.g., processor 404). Processor 404 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 404, device 402 may utilize memory 406 and/or data storage 408 for the storage of accessible data, such as instructions, values, etc. Communication interface 410 facilitates communication with components, such as processor 404 via bus 414 with components not accessible via bus 414. Communication interface 410 may be embodied as a network port, card, cable, or other configured hardware device. Additionally or alternatively, human input/output interface 412 connects to one or more interface components to receive and/or present information (e.g., instructions, data, values, etc.) to and/or from a human and/or electronic device. Examples of input/output devices 430 that may be connected to input/output interface include, but are not limited to, keyboard, mouse, trackball, printers, displays, sensor, switch, relay, speaker, microphone, still and/or video camera, etc. In another embodiment, communication interface 410 may comprise, or be comprised by, human input/output interface 412. Communication interface 410 may be configured to communicate directly with a networked component or utilize one or more networks, such as network 420 and/or network 424.

Network 130 may be embodied, in whole or in part, as network 420. Network 420 may be a wired network (e.g., Ethernet), wireless (e.g., WiFi, Bluetooth, cellular, etc.) network, or combination thereof and enable device 402 to communicate with networked component(s) 422. In other embodiments, network 420 may be embodied, in whole or in part, as a telephony network (e.g., public switched telephone network (PSTN), private branch exchange (PBX), cellular telephony network, etc.)

Additionally or alternatively, one or more other networks may be utilized. For example, network 424 may represent a second network, which may facilitate communication with components utilized by device 402. For example, network 424 may be an internal network to a business entity or other organization, whereby components are trusted (or at least more so) that networked components 422, which may be connected to network 420 comprising a public network (e.g., Internet) that may not be as trusted.

Components attached to network 424 may include memory 426, data storage 428, input/output device(s) 430, and/or other components that may be accessible to processor 404. For example, memory 426 and/or data storage 428 may supplement or supplant memory 406 and/or data storage 408 entirely or for a particular task or purpose. As another example, memory 426 and/or data storage 428 may be an external data repository (e.g., server farm, array, “cloud,” etc.) and enable device 402, and/or other devices, to access data thereon. Similarly, input/output device(s) 430 may be accessed by processor 404 via human input/output interface 412 and/or via communication interface 410 either directly, via network 424, via network 420 alone (not shown), or via networks 424 and 420. Each of memory 406, data storage 408, memory 426, data storage 428 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 430 may be a router, switch, port, or other communication component such that a particular output of processor 404 enables (or disables) input/output device 430, which may be associated with network 420 and/or network 424, to allow (or disallow) communications between two or more nodes on network 420 and/or network 424. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® CortexTMM microprocessors, ARM® Cortex-A and ARIVI926EJS™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system, comprising:
a network interface to a network;
a data storage;
a processor; and
wherein the processor:
determines a time event has occurred, the time event being associated with a user;
in response to the occurrence of the time event, accessing a corresponding calendar of the user to determine if the user has a subsequent meeting scheduled for the user;
upon determining a subsequent meeting is scheduled for the user, generating a delay notification message; and
sending the delay notification message, via the network, to at least one user associated with the subsequent meeting.

2. The system of claim 1, wherein the sending the delay notification message to at least one user associated with the subsequent meeting comprises sending the message to a server wherein, upon receipt of the delay notification message, the server provides the delay notification message to the at least one user associated with the subsequent meeting.

3. The system of claim 2, wherein the server comprises a conferencing server.

4. The system of claim 3, wherein server alters at least one of a start time, end time, or duration of the subsequent meeting for all attendees thereof.

5. The system of claim 2, wherein the server comprises a messaging server.

6. The system of claim 5, wherein the messaging server, upon receiving the delay notification message, propagates the delay notification message to a previously determined set of all invitees of the subsequent meeting and wherein the previously determined set of all invitees is less than all invitees.

7. The system of claim 2, wherein:
the server comprises a logic to receive messages in a first communication protocol;
wherein the processor comprises logic to generate the delay notification message utilizing a second protocol message;
wherein the server and the processor negotiate a common protocol selected from the first communication protocol, the second communication protocol, and a third communication protocol different from both the first communication protocol and the second communication protocol; and
wherein the processor sends the delay notification message to the server in a form utilizing the common protocol.

8. The system of claim 2, wherein:
the server comprises a presence server maintaining presence status for the user; and
upon receiving the delay notification message, updates a presence record for the user wherein the update indicates the delay.

9. A method, comprising:
determining a time event has occurred, the time event being associated with a user;
in response to the occurrence of the time event, accessing a corresponding calendar of the user to determine if the user has a subsequent meeting scheduled for the user;
upon determining a subsequent meeting is scheduled for the user, generating a delay notification message; and
sending the delay notification message, via a network, to at least one user associated with the subsequent meeting.

10. The method of claim 9, wherein sending the delay notification message to at least one user associated with the subsequent meeting further comprises sending the message to a server wherein, upon receipt of the delay notification message, the server provides the delay notification message to the at least one user associated with the subsequent meeting.

11. The method of claim 10, wherein the server comprises a conferencing server.

12. The method of claim 11, wherein server alters at least one of a start time, end time, or duration of the subsequent meeting for all attendees thereof.

13. The method of claim 10, wherein the server comprises a messaging server.

14. The method of claim 13, further comprising:
the messaging server, upon receiving the delay notification message, propagating the delay notification message to a previously determined set of all invitees of the subsequent meeting.

15. The system of claim 10, further comprising:
updating a presence record for the user wherein the update indicates the delay in response to receiving the delay notification message.

16. A system, comprising:
means to determine a time event has occurred, the time event being associated with a user;
means to, in response to the occurrence of the time event, access a corresponding calendar of the user to determine if the user has a subsequent meeting scheduled for the user;
means to, upon determining a subsequent meeting is scheduled for the user, generate a delay notification message; and
means to send the delay notification message, via a network, to at least one user associated with the subsequent meeting.

17. The system of claim 16, wherein in the means to send the delay notification message to at least one user associated with the subsequent meeting further comprises means to send the message to a server wherein, upon receipt of the delay notification message, the server provides the delay notification message to the at least one user associated with the subsequent meeting.

18. The system of claim 16, further comprising means to alters at least one of a start time, end time, or duration of the subsequent meeting for all attendees thereof in response to the delay notification message.

19. The system of claim 16, further comprising means to, upon receiving the delay notification message, propagate the delay notification message to a previously determined set of all invitees of the subsequent meeting, wherein the previously determined set of all invitees is less than all invitees.

20. The system of claim 16, further comprising, means to convert the delay notification message into at least two messages each having different formats for use by two or more of a messaging server, a presence server, a conferencing server, and a conferencing multimedia server.
